(19) United States
(12) Patent Application Publication
(10) Pub. No.: US 2023/0222610 A1
(43) Pub. Date: Jul. 13, 2023

(54) Virtual Re-Inspection Process for a Property

(71) Applicant: Wells Fargo Bank, N.A., San Francisco, CA (US)

(72) Inventors: Zachary Daniel Dawson, Minneapolis, MN (US); Randall P. Gilster, Wayzata, MN (US)

(21) Appl. No.: 16/214,915

(22) Filed: Dec. 10, 2018

(51) Int. Cl. G06Q 50/16; G06T 7/00; G06F 16/583; G06F 16/587

(52) U.S. Cl. CPC G06Q 50/163; G06T 7/0002; G06F 16/583; G06F 16/587

(57) ABSTRACT

A method implemented on an electronic computing device for verifying a re-inspection of a property includes receiving data regarding the inspection of the property. A determination is made from the data whether requirements for the inspection have been met. When a determination is made that one or more requirements of the inspection have not been met, a determination is made whether a virtual re-inspection is possible. When a determination is made that the virtual re-inspection is possible, one or more photographs are received at the electronic computing device corresponding to the virtual re-inspection. A determination is made from the one or more photographs whether the virtual re-inspection has been successfully completed.

### BACKGROUND

When properties are sold or appraised, an inspection is often required or desired. For example, appraisals for home sales and remodels can be contingent on certain follow-up items being completed. Examples include a handrail that may need to be installed, woodworking that may need to be completed, one or more items that may need to be repaired, etc. When a follow-up inspection is required to verify that the follow-up items have been completed, additional cost and time can be added to the sale of the property.

### SUMMARY

Embodiments of the disclosure are directed to a method implemented on an electronic computing device for verifying a re-inspection of a property. The method comprises: receiving data regarding the inspection of the property; determining from the data whether requirements for the inspection have been met; when a determination is made that one or more requirements of the inspection have not been met, determining whether a virtual re-inspection is possible; when a determination is made that the virtual re-inspection is possible, receiving from the electronic computing device one or more photographs corresponding to the virtual re-inspection; and determining from the one or more photographs whether the virtual re-inspection has been successfully completed.

In another aspect, a method implemented on an electronic computing device for verifying an inspection of a home comprises: activating a mobile financial software application on the electronic computing device; using the mobile financial software application, receiving data regarding the inspection of the home; using the mobile financial software application, displaying information as to whether requirements for the inspection have been met; when one or more requirements of the inspection have not been met, indicating, using the mobile financial software application, whether a virtual re-inspection is possible; when an indication is made that the virtual re-inspection is possible, activating a photo application; and receiving at the electronic computing device one or more photographs corresponding to the virtual re-inspection.

In yet another aspect, an electronic computing device comprises: a processing unit; and system memory, the system memory including instructions which, when executed by the processing unit, cause the electronic computing device to: receive data regarding the inspection of the home; determine from the data whether any items in the home need to be repaired or completed to satisfactorily complete the inspection; when a determination is made that one or items in the home need to be repaired or completed to satisfactorily complete the inspection, determine whether a virtual re-inspection is possible; when a determination is made that the virtual re-inspection is possible: receive from the electronic computing device one or more photographs corresponding to the one or more items in the home that need to be repaired or completed; receive from the electronic computing device metadata associated with the one or more photographs; and determine from the one or more photographs and the metadata whether the one or more items have been satisfactorily repaired or completed.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a virtual re-inspection process for a property.

FIG. 2 shows example modules of the virtual re-inspection engine of FIG. 1.

FIG. 3 shows an example method for conducting a virtual re-inspection of a home.

FIG. 4 shows an example graphical user interface (GUI) that can be rendered on the customer electronic computing device of FIG. 1.

FIG. 5 shows another GUI that can be rendered on the customer electronic computing device of FIG. 1.

FIG. 6 shows yet another GUI that can be rendered on the customer electronic computing device of FIG. 1.

FIG. 7 shows yet another GUI that can be rendered on the customer electronic computing device of FIG. 1.

FIG. 8 shows yet another GUI that can be rendered on the customer electronic computing device of FIG. 1.

FIG. 9 shows example physical components of the organization server computing device of the system of FIG. 1.

### DETAILED DESCRIPTION

The present disclosure is directed to systems and methods for a virtual re-inspection process for a property that can be used in lieu of an onsite manual re-inspection. For example, the property can be a commercial property that can include on or more buildings. The virtual re-inspection can be used to verify that certain items identified in an initial inspection of the property have been satisfactorily completed. The virtual re-inspection can be faster and less expensive than the onsite manual re-inspection. In a preferred embodiment discussed in this disclosure, the property is described as a home. However, in other implementations, other types of properties can be used, such as commercial properties.

An initial inspection of the home is usually required as part of an appraisal of the home's value. In addition, when the home is up for sale, many buyers may want the home to be inspected before completing the sale. The initial inspection may identify items in the home that need attention or fixing before the home sale can be completed. Examples of items in the home that may require attention or fixing can include broken or missing shingles on a roof, cracked siding on the home, broken windows, missing or broken handrails, torn carpeting, leaking pipes, holes or cracks in doors, damaged sheet rock, and other similar items.

When an item that requires attention is minor, for example a missing roof shingle or a broken handrail, verification that the item has been satisfactorily corrected can be obtained by having the homeowner take a photograph of the item after it has been repaired. For example, the homeowner can take a photograph of an area of the roof that has the missing shingle before repairs are made and after repairs are made to confirm that the repairs have been made. The photograph can include metadata such as a geolocation of where the photograph was made and a timestamp that indicates the date and time for the photo. The photograph and the metadata can provide evidence that the missing shingle has been satisfactorily corrected as part of a virtual re-inspection process.

When a needed repair, such as a broken or leaking pipe, is more extensive, a manual inspection may be needed. The systems and methods allow for a determination to be made as to whether a repair needs to be verified by an onsite manual inspection, or whether a virtual inspection can be used instead.

When a virtual re-inspection is determined to be permissible, photographs can be taken for the virtual re-inspection via a software application on a smartphone of the homeowner. The software application can include a photo application that can provide both a time stamp and a geolocation for the photo. The software application can be either previously installed on the smartphone of the homeowner, or can be downloaded from an electronic computing device, typically a server computing device, from an organization associated with the home sale or home appraisal. For example, the organization associated with the home sale or the home appraisal can be a financial institution such as a bank, a real estate company, a mortgage company, or another type of organization. For this disclosure, the organization is assumed to be a bank.

Virtual re-inspections can be more efficient and less expensive than manual re-inspections. Home appraisals, typically need to be completed within a specified period of time. Implementing a re-inspection via having the homeowner take a photograph of the items that need to be re-inspected can save time and money over scheduling an onsite manual inspection. For some initial home inspections, when items are identified that need to be repaired or completed, a time deadline can be set for re-inspection. In addition, a warning date can be set before the deadline. When a re-inspection needs to be performed and is not completed by the warning date, the homeowner may receive a notification that the home appraisal or a closing on the home can be in jeopardy. Virtual re-inspections can permit the home appraisal to be completed faster than a manual re-inspection.

In some implementations, augmented reality (AR) can be used to implement a virtual re-inspection. AR can be implemented via a head-mounted display, such as special eyeglasses or goggles, or via a software application on a smart phone. A homeowner using an AR device, for example an AR headset, with an authorized camera or scanning application may be able to view an item to be re-inspected, take a photograph of the item using a voice command, and send the photograph to a server computing device using another voice command.

In some implementations, a financial application, such as a loan tracker, mobile wallet, or other mobile financial application, can be used to manage both mortgage information and re-inspection information. The financial application can include leveraging the AR device to capture and send the photographs during the re-inspection.

The systems and methods discussed herein are directed to a computing technology that can process results from a virtual re-inspection of the home to verify that identified repairs have been made and/or that items identified as needing to be completed have been completed. The processing of the results from the virtual re-inspection permits the home inspection to be completed faster than if a manual re-inspection were needed. Therefore, the systems and methods provide efficiencies in processing home inspections. Because virtual re-inspections permit home inspections to be completed faster than manual re-inspections, an organizational server computer that processes the virtual re-inspections can process a greater number of virtual re-inspections than if re-inspection results were provided manually.

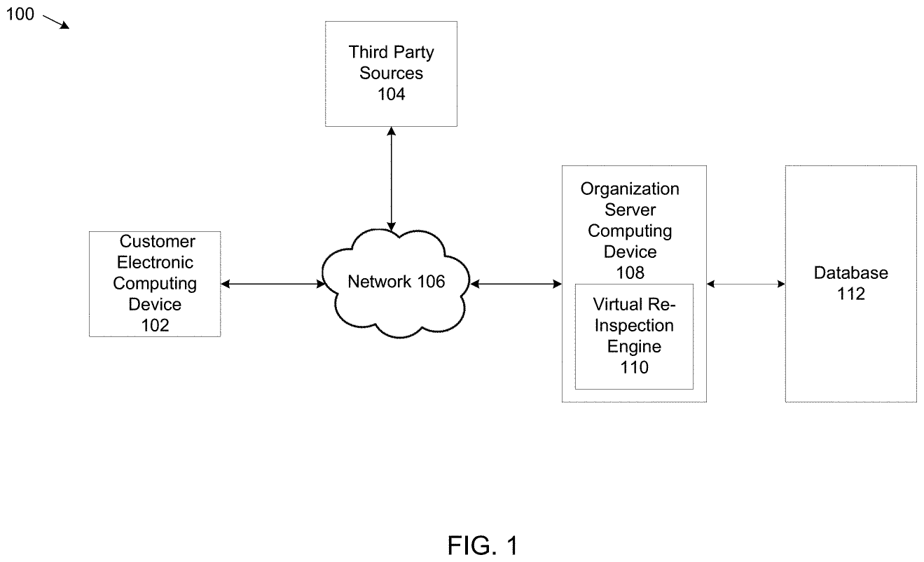

FIG. 1 shows an example system 100 that can support a virtual re-inspection process. System 100 includes a customer electronic computing device 102, third party sources 104, a network 106, an organization server computing device 108 and a database 112. Organization server computing device 108 includes a virtual re-inspection engine 110. More, fewer, or different components are possible.

The example customer electronic computing device 102 is an electronic computing device of a customer of an organization that can support the virtual re-inspection process. The electronic computing device can be one or more of a desktop computer, a laptop computer, or a mobile computing device, such as a tablet computer or a smartphone. Other electronic computing devices are possible. The software application that includes the photo application discussed earlier herein can be installed on or downloaded to customer electronic computing device 102. The software application can be the financial application, mentioned earlier herein, and discussed in more detail later herein, that comprises, for example, the loan tracker and/or mobile wallet.

The example third party sources 104 are electronic computing devices, typically server computing devices, of third party sources that can provide information to organization server computing device 108 regarding the home being inspected, the original inspection, and other information. Third party sources 104 can include home inspection companies. Third party sources 104 can also include organizations that can provide a manual or an computer vision analysis of photographs obtained via the virtual re-inspection process. Examples of third party sources 104 can include a realtor, a financial institution, a government organization, for example the Federal Housing Administration, a home inspection company, and an organization that specializes in a computer vision analysis or a manual inspection analysis. For example, a computer vision analysis can be performed by a third party source 104, such as Google, via an application programming interface (API). Other third party sources 104 are possible.

The example network 106 is a computer network and can be any type of wireless network, wired network and cellular network, including the Internet. Customer electronic computing device 102 and third party sources 104 can communicate with organization server computing device 108 using network 106.

The example organization server computing device 108 is a server computing device of an organization that can implement the virtual re-inspection process. Examples of such an organization can include a financial institution, such as a bank, a realty company, and a mortgage company. Other examples are possible.

The example virtual re-inspection engine 110 processes an inspection record for the home and determines an eligibility for a virtual re-inspection process for the home. When the home is deemed eligible for virtual re-inspection, the virtual re-inspection determination module can analyze results of the virtual re-inspection and determines whether the virtual re-inspection has been successfully completed. In some implementations, the virtual re-inspection engine 110 can receive results of a manual examination of photographs of repairs taken during the virtual re-inspection of the home. In other implementations, the virtual re-inspection engine 110 can use a computer vision application to automatically analyze the photographs of the repairs and determine whether the virtual re-inspection has been successfully completed. The virtual re-inspection engine is discussed in more detail later herein.

The example database 112 is a database associated with the organization of organization server computing device 108. Database 112 can store personal and financial information for the customer and for family members of the customer. Database 112 can also store results of an initial inspection of the home and details regarding the virtual re-inspection of the home. Database 112 can be distributed over a plurality of databases. Organization server computing device 108 can be programmed to query (e.g. using Structured Query Language, SQL) database 112 to obtain the military customer information.

An example schema including, but not limited to, customer information stored in database 112 is shown below. More, fewer, or different fields are possible.
Customer Name—the name of the customer of the organization, typically the homeowner;
Customer ID at organization—a set of letters, numbers, or other symbol that uniquely identifies the customer at the organization;
Appraised value of home—a number representing a current appraised value of the home;
Family member data—a pointer to an area of memory providing names, ages, employers and financial account information for the customer and for family members of the customer;
Home inspection status—a current status of a home inspection; example statuses can be completed initial inspection, pending re-inspection and completed final inspection;
Initial inspection report—a pointer to an initial inspection report for the home;
Pending repair items—a pointer to a list of items in the home that need repair, based on the initial inspection report;
Pending completion items—a pointer to a list of items in the home than need to be completed, based on the initial inspection report;
Virtual re-inspection eligibility status—a status indicating whether the home is eligible for a virtual re-inspection;
Final inspection report—a pointer to a final inspection report for the home;

The above schema permits the database to be queried for data such data as credit limits for a customer and categorized budgeted dollar amounts for the customer.

As an example, the following messaging format can be used between the organization server computing device 108 and the database 112 to obtain the base maximum credit limit for the customer.

| | |
|---|---|
| Customer ID | Home inspection status |

As an example, the database 112 can use the following messaging format in responding to such a request. In this example, a pending re-inspection status is returned in response to the request.

| | |
|---|---|
| Customer ID | Pending re-inspection |

As another example, the following messaging format can be used between the organization server computing device 108 and the database 112 to obtain a list of items that need to be repaired, based on the initial inspection report.

| | |
|---|---|
| Customer ID | Pending repair items |

As an example, the database 112 can use the following messaging format in responding to such a request. In this example, a dollar amount for the system recommended dollar amount for housing is returned in response to the request.

| | | |
|---|---|---|
| Customer ID | Shingle on right front | Hand rail on staircase |
| | side of roof | |

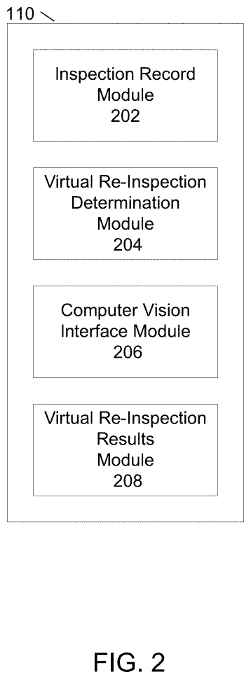

FIG. 2 shows example modules of virtual re-inspection engine 110. The modules include an inspection record module 202, a virtual re-inspection determination module 204, and a computer vision interface module 206, and a virtual re-inspection results module 208. More, fewer, or different modules are possible.

The example inspection record module 202 receives and processes information pertaining to an inspection of the home. In one implementation, the information can be received from a third party source 104, for example a third party home inspection company, which conducted the inspection of the home. In another implementation, the information can be received from a third party source 104 that contracted with the third party home inspection company to conduct the inspection of the home. The received information can comprise one or more of the actual home inspection report and a list and/or description of deficient items identified as a result of the home inspection.

The example virtual re-inspection determination module 204, processes the information received at the inspection record module 202 and determines whether any items identified as needing repair or completion can be verified as being repaired or completed via a virtual re-inspection. As discussed earlier herein, the virtual re-inspection can comprise having the customer take photographs of the repaired or completed items and sending the photographs to organization server computing device 108.

Virtual re-inspection determination module 204 can determine which, if any, items are eligible for home inspection by reviewing the nature of the repair or work needed for completion. When the repair or work needed for completion is simple, and can be easily verified with a photo, virtual re-inspection determination module 204 can determine that a virtual re-inspection is sufficient. However, when a determination is made that the repair or work for completion is more complex, for example repairing or replacing a pipe, virtual re-inspection determination module 204 can determine that a manual inspection is warranted.

In some implementations, the computer vision interface module 206 can be used to interface with a third party source 104 that can perform a computer vision analysis of the photographs from the virtual re-inspection. The computer vision analysis can comprise an automatic analysis of digital images of the items photographed during the virtual re-inspection. The computer vision interface module 206 can send the photographs from the virtual re-inspection to the third party source 104 that can perform the computer vision analysis of the photographs. The computer vision interface module 206 can also receive results from the computer vision analysis and forward the results to virtual re-inspection results module 208.

In some implementations, organization server computing device 108 can include computer vision functionality. In these implementations, computer vision interface module 206 can perform the virtual re-inspection by itself, without having to use a third party source. The computer vision functionality can include the ability to recognize the one or more items that are in need of completion or repair and automatically analyze the photographs to an extent necessary to confirm that the items in need of completion have been completed and that the repairs have been made.

The example virtual re-inspection results module 208 receives results from a manual re-inspection of the photographs or from an analysis received by or performed by computer vision interface module 206, and determines whether the virtual re-inspection has been successfully completed. Successful completion comprises validating that items identified to be completed have been successfully completed that items identified as needing repair have been successfully repaired.

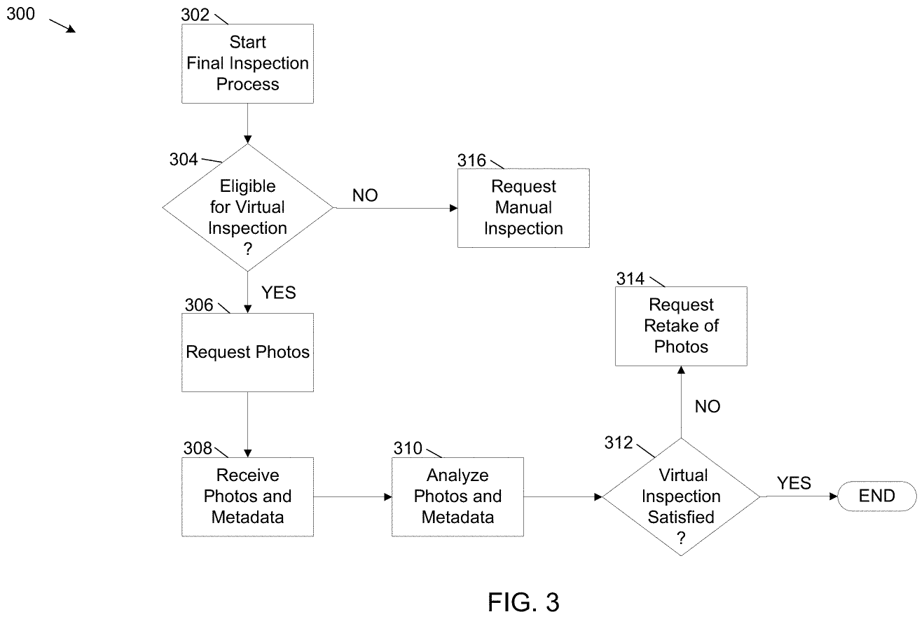

FIG. 3 shows a flowchart for an example method 300 for conducting a virtual re-inspection for a home.

At operation 302, a final inspection process is started for the home. The final inspection process starts after an initial inspection of the home has been completed, after one or more items have been identified as needing repair or completion, and after the identified items have been repaired or completed.

At operation 302, a determination is made as to whether the final inspection can be a virtual re-inspection. The final inspection can be eligible for a virtual re-inspection when the determination is made that the repairs or completions for the identified items can be verified via photographs of the repairs or completions.

At operation 304, when a determination is made that repairs or completions are extensive enough that a verification of the repairs or completions via photographs would not be adequate, at operation 316, a request is made to perform a manual re-inspection for the home. The request to perform the manual re-inspection can be sent to one of third party sources 104.

At operation 304, when a determination is made that the repairs or completions are such that they can be verified by the photographs, at operation 306, a request is made to the homeowner to submit the photographs to an organization that can verify the photographs. For method 300, the request is made to submit the photographs to organization server computing device 108.

At operation 308, the photographs of the repairs or completions are received at organization server computing device 108. In addition, metadata is included with the photographs. The metadata includes information such as a geolocation at which the each photograph was taken and a timestamp associated with each photograph.

At operation 310, an analysis is performed for the received photographs to determine whether the repairs or completions have been satisfactorily completed. In one example implementation, the analysis is performed manually by a human who visually examines the photographs. For this implementation, the human can be an employee of the organization. In some instances, the organization can send the photographs to a third party, for example a third party source 104, for analysis.

In another other example implementation, the analysis can be performed automatically via computer vision. When the organization has a capability to implement computer vision, the computer vision analysis can be performed via organization server computing device 108 or another electronic computing device associated with the organization. Alternatively, when the organization does not have the capability of implementing a computer vision analysis, the computer vision implementation can be performed by a third party source 104 that has a capability of analyzing the photographs via computer vision.

At operation 312, the results of the analysis are received, and a determination is made as to whether the virtual inspection has been satisfied.

At operation 312, when the determination has been made that the virtual inspection has not been satisfied, at operation 314, a request is sent to the homeowner, for example via a message sent to customer electronic computing device 102, to retake the photographs. In some cases, when a determination has been made that the repairs are not sufficient or an item has not been satisfactorily completed, the message can also indicate that additional repairs or work on the item is necessary.

At operation 312, when a determination is made that the virtual inspection has been satisfactorily completed, method 300 ends.

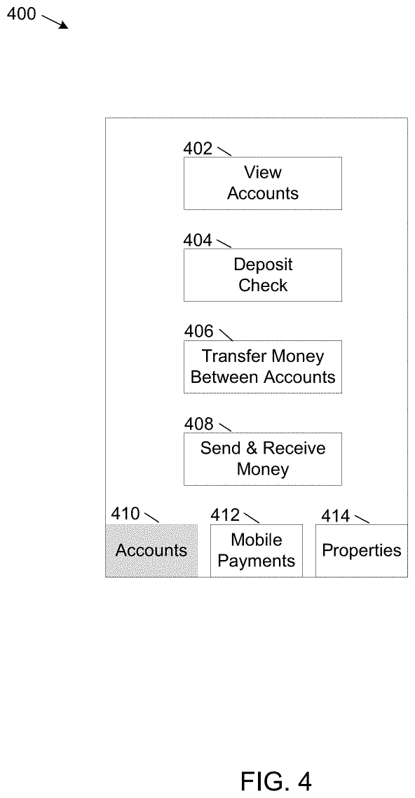

FIGS. 4-7 show example graphical user interfaces (GUIs) that can be rendered on a mobile electronic computing device of the customer, for example on customer electronic computing device 102. The GUIs can be part of a mobile financial application that can be installed on the mobile electronic computing device of the customer. The mobile financial application can be used to track different financial aspects, such as information about a user's financial accounts.

For example, the mobile financial application can include a wallet, holding payment information for checking/savings accounts, credit/debit cards, etc. The mobile financial application can also include mortgage information, re-inspection functionality, and other functionality.

The mobile financial application permits the mobile electronic computing device to provide multiple types of functionality, including financial account information, the ability to make payments using the mobile electronic computing device, and functionality for the customer's home, including implementing virtual re-inspections. Typically, the mobile electronic computing device is a smartphone, although other mobile electronic computing devices can be used.

In some implementations, the GUIs of FIGS. 4-7 can be rendered on an AR device, and the mobile financial application can be implemented on the AR device. In some implementations, the AR device can be integrated with the mobile financial application on the mobile electronic computing device, for example via a wireless connection, such as a Bluetooth connection. When the AR device is integrated with the mobile financial application on the mobile electronic computing device, a camera on the AR device can be used to take photographs during the re-inspection.

FIG. 4 shows an example GUI 400 of the mobile financial application. GUI 400 includes three example tabs—accounts 410, mobile payments 412, and properties 414. More, fewer, or different tabs can be used. GUI 400 can be rendered when the customer selects the accounts 410 tab, shown highlighted in gray in FIG. 4.

When the accounts 410 tab is selected, GUI 400 shows example buttons for view accounts 402, deposit check 404, transfer money between accounts 406 and send and receive money 408. Selecting the view accounts 402 button permits a display of current financial account information for the customer at the financial institution, such as balances and transactions for accounts like checking accounts, savings accounts, investment accounts, etc. In other embodiments, the accounts can include mortgage accounts.

Selecting the deposit check 404 button permits the customer to deposit a check at the financial institution. Selecting the transfer money between accounts 406 button permits the customer to transfer money between the customer's current financial accounts. Selecting the send & receive money 408 button permits the customer to send money to a third party or to receive money from a third party. The third party can be an individual or another organization.

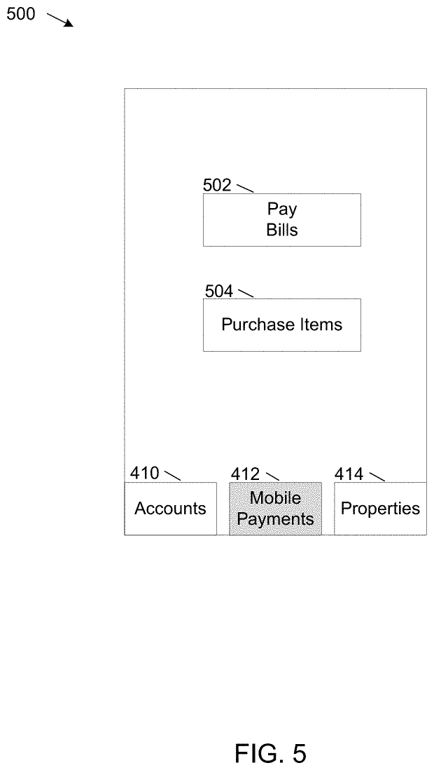

FIG. 5 shows an example GUI 500 of the financial application. GUI 500 includes the accounts 410 tab, the mobile payments 412 tab, and the properties 414 tab. In FIG. 5, the mobile payments 412 tab is shown highlighted in gray, indicating that the mobile payments 412 tab has been selected using, for example, the customer's finger or other input method.

When the mobile payments 412 tab is selected, GUI 500 shows example buttons for pay bills 502 and purchase items 504. Selecting the pay bills 502 button permits the mobile financial application to be used for bill pay. Selecting the purchase items 504 button permits the mobile electronic computing device to be used to purchase items at a retail store, using credit card information stored on the mobile electronic computing device.

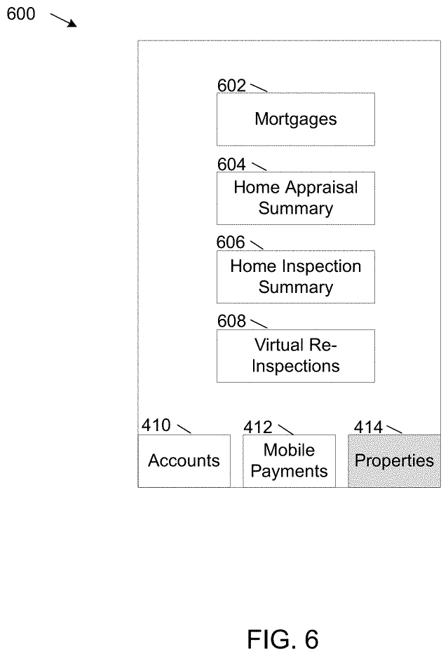

FIG. 6 shows an example GUI 600 of the mobile financial application. GUI 600 includes the account 410 tab, the mobile payments 412 tab, and the properties 414 tab. In FIG. 6, the properties 414 tab is shown highlighted in gray, indicating that the properties 414 tab has been selected.

When the properties 414 tab is selected, GUI 600 shows example buttons for mortgages 602, home appraisal summary 604, home inspection summary 606, and virtual re-inspections 608. More, fewer, or different buttons can be used.

Selecting the mortgages 602 button permits a display of information for mortgages issued or currently processed by the financial institution for one or more properties currently owned by the customer. The information can include items such as a date that a mortgage was issued, and an initial amount, term, interest rate, amount remaining and number of months remaining for each mortgage. Other information is possible.

Selecting the home appraisal summary 604 button permits a display of home appraisal summary information for each home currently owned by the customer for which the financial institution has information. The home appraisal summary can include information such as a data of the home appraisal, a currently appraised value of the home, and a date and status of any inspections performed on the home. Other home appraisal summary information is possible. The home appraisal summary can be obtained through querying one or more of third party sources 104. Once obtained, the home appraisal summary can be cached on organization server computing device 108.

Selecting the home inspection summary 606 button permits a display of information of any inspections of the home. The inspection information can include such items as a date of each inspection, a status of each inspection, and information regarding any items in the home, identified in the inspection, that require repairs or need to be completed. The information can also indicate whether any repair or completion action taken for the identified items can be verified by a virtual re-inspection. The home inspection summary can be obtained through querying one or more of third party sources 104. Once obtained, the home appraisal summary can be cached on organization server computing device 108.

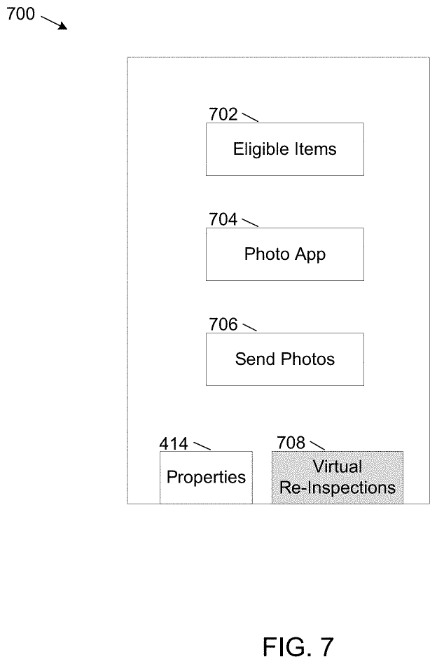

Selecting the virtual re-inspections 608 button permits a virtual re-inspection of the identified items to be initiated via the mobile financial application. Selecting the virtual re-inspections 608 button activates GUI 700, shown in FIG. 7.

FIG. 7 shows the example GUI 700 of the mobile financial application. GUI 700 includes an eligible items 702 button, a photo app 704 button and a send photos 706 button. GUI 700 also includes a virtual re-inspections 708 tab, which is highlighted in gray to show that the virtual re-inspections 708 tab has been selected.

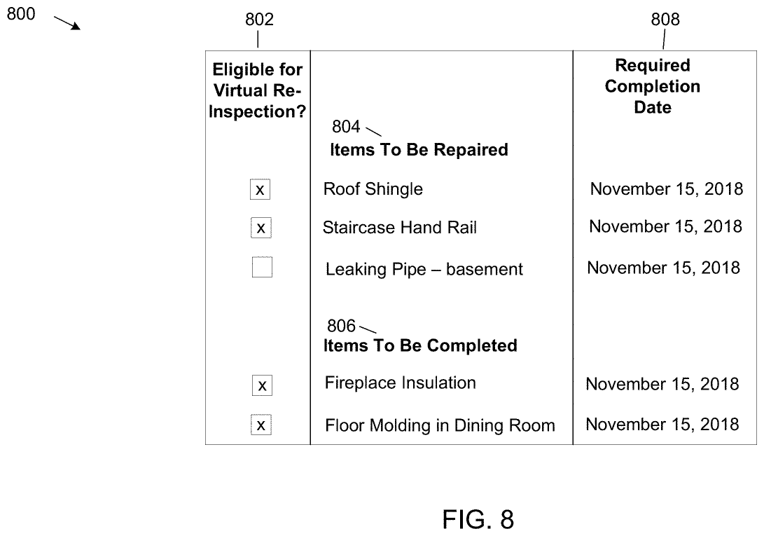

Selecting the eligible items 702 button permits a display of all items identified in the inspection of the home for which repairs or needed completions can be verified via a virtual re-inspection. An example display of items identified in the inspection of the home is shown in FIG. 8, and discussed later herein.

Selecting the photo app 704 button activates a photographic application of the mobile financial application. The photographic application is an application approved by the financial institution to obtain photographs of the identified items during the re-inspection process. The photographic application can be authorized by the financial institution as a way to prevent against fraud. For example, each photograph taken using the photographic application can include an identifying marker of the financial institution. The photographic application can also provide a time stamp and a geolocation for each photograph taken using the photographic application.

Selecting the photo app 704 button also activates a camera on the mobile electronic computing device of the customer. The customer can use the camera during the virtual re-inspection to photograph each item that has been repaired or completed. Each photograph can be stored on the mobile electronic computing device of the customer. When an AR device is integrated with the mobile electronic computing device of the customer, selecting the photo app 704 button can activate a camera on the AR device. Alternatively, the camera on the AR device can be activated via a voice command.

Selecting the send photos 706 button can send each stored photograph for analysis to verify that the virtual re-inspection has been successfully completed. The stored photographs can be sent to organization server computing device 108. A determination can be made at organization server computing device 108 as to where the photographs are to be analyzed. As discussed earlier herein, in some implementations, the verification analysis can be performed manually. In other implementations, the verification analysis can be performed automatically via a computer vision software application. Also, as discussed earlier herein, in some implementations the stored photographs can be sent to one of third party sources 104 for the verification analysis. In other implementations, the verification analysis can be performed by organization server computing device 108.

FIG. 8 shows an example GUI 800 of the mobile financial application. GUI 800 shows an example display of items identified in the inspection of the home than need repairs or completion. GUI 800 is rendered when the eligible items 702 button of GUI 700 is selected.

GUI 800 includes a list of items to be repaired 804 as a result of an initial inspection, a list of items to be completed 806 as a result of the initial inspection, a required completion date 808 for the items, and a column 802 indicating whether each item is eligible for a virtual re-inspection. Column 802 includes a checkbox adjacent to each item. When an item is eligible for virtual re-inspection, a corresponding checkbox is checked.

As shown in FIG. 8, three items are in need of repair as a result of the initial inspection. The three example items in need of repair are a roof shingle, a staircase hand rail and a leaking pipe in the basement. Of these three items, only the roof shingle and the staircase hand rail are eligible for a virtual re-inspection, as indicated by the checked checkbox adjacent to these items. The leaking pipe in the basement requires a manual inspection to verify that the leaking pipe has been repaired.

Also, as shown in FIG. 8, two items are in need of completion—fireplace insulation and floor molding in the dining room. Both of these items can be verified via a virtual re-inspection.

Also, as shown in FIG. 8, the required completion date 808 is Nov. 15, 2008 for all the items to be repaired 804 and for all the items to be completed. Typically, the required completion date is the same for all items in order to meet an objective, such as a closing date for the home.

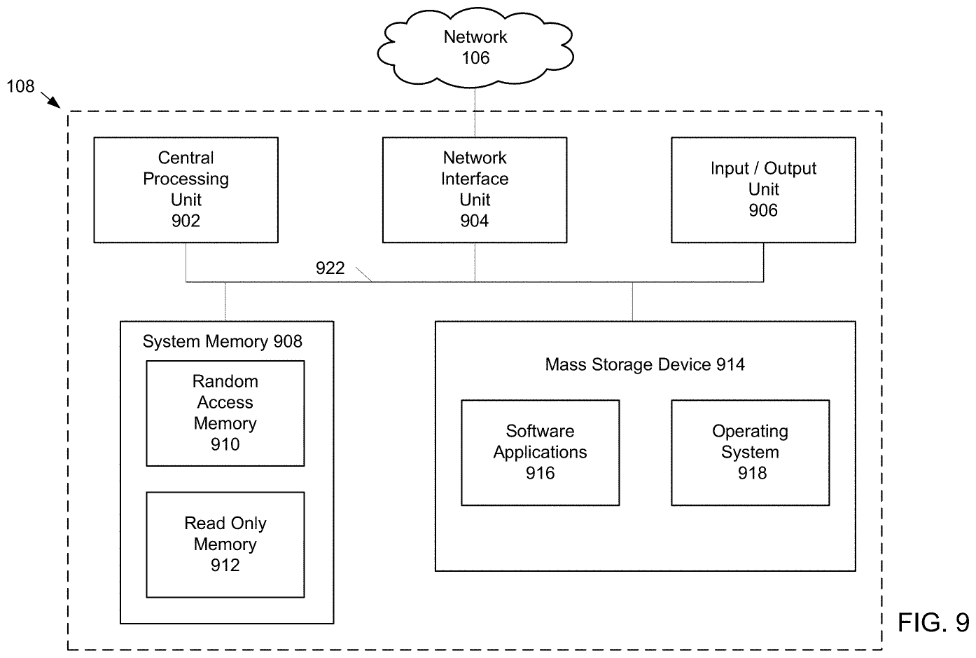

As illustrated in the example of FIG. 9, organization server computing device 108 includes at least one central processing unit (“CPU”) 902, also referred to as a processor, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the organization server computing device 108, such as during startup, is stored in the ROM 912. The organization server computing device 108 further includes a mass storage device 914. The mass storage device 914 is able to store software instructions and data. Some or all of the components of the organization server computing device 108 can also be included in customer electronic computing device 102 and/or one or more computing devices associated with third party sources 104.

The mass storage device 914 is connected to the CPU 902 through a mass storage controller (not shown) connected to the system bus 922. The mass storage device 914 and its associated computer-readable data storage media provide non-volatile, non-transitory storage for the organization server computing device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the organization server computing device 108.

According to various embodiments of the invention, the organization server computing device 108 may operate in a networked environment using logical connections to remote network devices through the network 106, such as a wireless network, the Internet, or another type of network. The organization server computing device 108 may connect to the network 106 through a network interface unit 904 connected to the system bus 922. It should be appreciated that the network interface unit 904 may also be utilized to connect to other types of networks and remote computing systems. The organization server computing device 108 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the organization server computing device 108 can store software instructions and data. The software instructions include an operating system 918 suitable for controlling the operation of the organization server computing device 108. The mass storage device 914 and/or the RAM 910 also store software instructions and software applications 916, that when executed by the CPU 902, cause the organization server computing device 108 to provide the functionality of the organization server computing device 108 discussed in this document. For example, the mass storage device 914 and/or the RAM 910 can store software instructions that, when executed by the CPU 902, cause the organization server computing device 108 to display received data on the display screen of the organization server computing device 108.

Although various embodiments are described herein, those of ordinary skill in the art will understand that many modifications may be made thereto within the scope of the present disclosure. Accordingly, it is not intended that the scope of the disclosure in any way be limited by the examples provided.

1-18. (canceled)

20. An electronic computing device comprises:
at least one processor; and
system memory, the system memory including instructions which, when executed by the at least one processor, cause the electronic computing device to:
query a database to request data regarding an inspection of a home, including: inspection status data defining a status of the inspection; pending repair items data providing one or more items in the home that need to be repaired; and virtual re-inspection eligibility status data indicating eligibility for a virtual re-inspection;
determine from the data whether any items in the home need to be repaired or completed to satisfactorily complete the inspection using the inspection status data from the database;
when a determination is made that the one or more items in the home need to be repaired or completed to satisfactorily complete the inspection, determine whether the virtual re-inspection is possible using the virtual re-inspection status data from the database;
when a determination is made that the virtual re-inspection is possible:
activate a financial software application on the electronic computing device, the financial software application being programmed to manage financial accounts and provide inspection functionality, wherein the financial accounts include at least one of a checking account and a savings account;
render, by the financial software application, a graphical user interface with functionality to access the at least one of the checking account and the savings account, the graphical user interface further including an inspection control which, upon activation, causes to be rendered:
an eligibility control which, upon activation, lists the one or more items for which repairs or needed completions can be verified via the virtual re-inspection;
a photograph control which, upon activation, executes an approved photographic application programmed to capture one or more photographs of the one or more items; and
a send control which, upon activation, is programmed to send the one or more photographs;
receive, upon activation of the send control from the financial software application of the electronic computing device, the one or more photographs corresponding to the one or more items in the home that need to be repaired or completed;
receive from the electronic computing device metadata associated with the one or more photographs, wherein the metadata includes a geolocation and a timestamp for each of the one or more photographs, the geolocation corresponding to the geolocation of the home;
forward the one or more photographs to an application programming interface of a remote computing device for automatically analyzing the one or more photographs using computer vision to identify the one or more items in the home that need to be repaired;
receive from the remote computing device results of the computer vision analysis; and
determine from the one or more photographs as analyzed by the computer vision and the metadata whether the one or more items have been satisfactorily repaired or completed; and
when a determination is made that the virtual re-inspection is not possible, require a manual re-inspection of the property.
